(19) United States
(12) Patent Application Publication
(10) Pub. No.: US 2005/0288804 A1
(43) Pub. Date: Dec. 29, 2005

(54) USB music player capable of receiving at least one portable memory

(76) Inventor: Tseng-Tien Peng, Taipei Hsien (TW)

Correspondence Address: TSENG-TIEN PENG, 235 Chung-Ho, P.O. BOX 10-69, Taipei, TW

(21) Appl. No.: 10/873,449

(22) Filed: Jun. 23, 2004

(51) Int. Cl. G06F 17/00

(52) U.S. Cl. 700/94

(57) ABSTRACT

A USB music player comprises one USB connecting slot for receiving one portable memory, such as a pen disk or a thumb disk, each having a respective USB connector so as to read music format stored in the two portable memories; wherein data is transferred and recorded between the two portable memories and the USB music player; a plurality of insertion hole and a plurality of buttons; wherein music signals are transferred to an external playing device through the insertion holes; the playing of music is controlled by the control keys. Moreover, there may be only one slot in the USB music player. A wire or wireless earphone set is connected to one of the plurality of insertion holes. A trumpet or an amplifier is connected to one of the plurality of insertion holes.

### FIELD OF THE INVENTION

The present invention relates to music players, and particular to a USB music player which can improve the defects in the prior art. The USB music player has at least one slot for receiving at least one portable memory, such as thumb disk, or pen disk, so that more music data can be accessed.

### BACKGROUND OF THE INVENTION

Currently, the data, especially MP3 formatted music is stored to a portable memory, such as thumb disk, or pen disk, so that music is played through the portable memory or using the portable memory through a computer. However, the prior art portable memory has the following defects. Firstly, the computer cannot be carried easily so that data in the portable memory cannot be recorded. Thereby, the use of the portable memory is limited. Moreover, the capacity of the portable memory is limited so that only finite number of music are stored, which is not sufficient to the user's requirement. Furthermore, the prior art prior art cannot be connected to a trumpet. Thereby, users must buy a portable memory with a larger memory capacity.

### SUMMARY OF THE INVENTION

Accordingly, the primary object of the present invention is to provide a USB music player, which can improve the defects in the prior art. The USB music player has at least one slot for receiving at least one portable memory so that more music data can be accessed.

The USB music player can be connected to a plurality of portable memories so that the user can select music in the portable memories. Thus more music can be stored and selected.

The data in the USB music player and portable memories can be transferred and recorded to one another without using a computer. The USB music player of the present invention has a simple structure, can be operated easily and has longer lifetime.

To achieve above objects, the present invention provides a USB music player which comprises one USB connecting slot for receiving one portable memory each having a respective USB connector so as to read music format stored in the two portable memories; wherein data is transferred and recorded between the two portable memories and the USB music player; and a plurality of insertion hole and a plurality of buttons; wherein music signals are transferred to an external playing device through the insertion holes; the playing of music is controlled by the control keys. Moreover, there may be only one slot in the USB music player. A wire or wireless earphone set is connected to one of the plurality of insertion holes. A trumpet or an amplifier is connected to one of the plurality of insertion holes.

The various objects and advantages of the present invention will be more readily understood from the following detailed description when read in conjunction with the appended drawing.

### BRIEF DESCRIPTION OF THE DRAWINGS

FIG. 1 is a schematic view showing the use of the USB music player of the present invention.

FIG. 2 is a perspective view of the USB music player according to the present invention.

FIG. 3 shows one embodiment of the present invention, wherein the USB music player is connected to an earphone set.

FIG. 4 shows another embodiment of the present invention, wherein the USB music player of the present invention is connected to a trumpet.

FIG. 5 shows a further embodiment of the present invention, wherein the USB music player of the present invention has only one slot.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

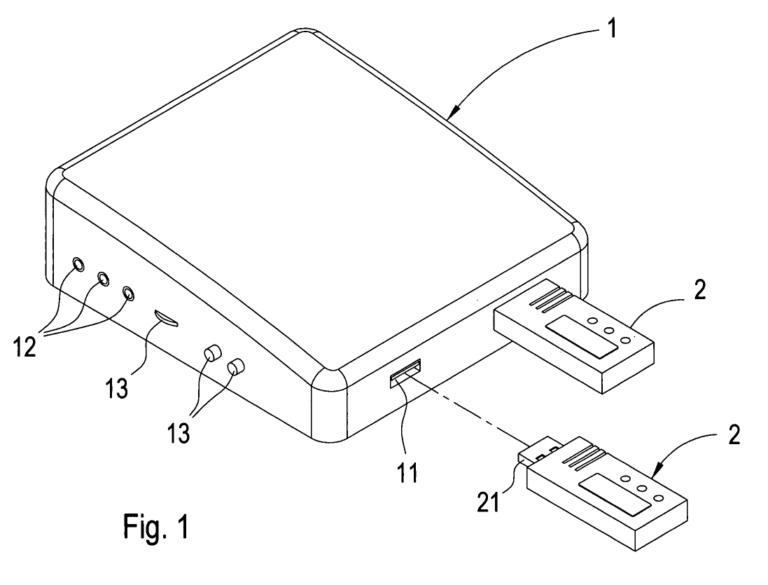

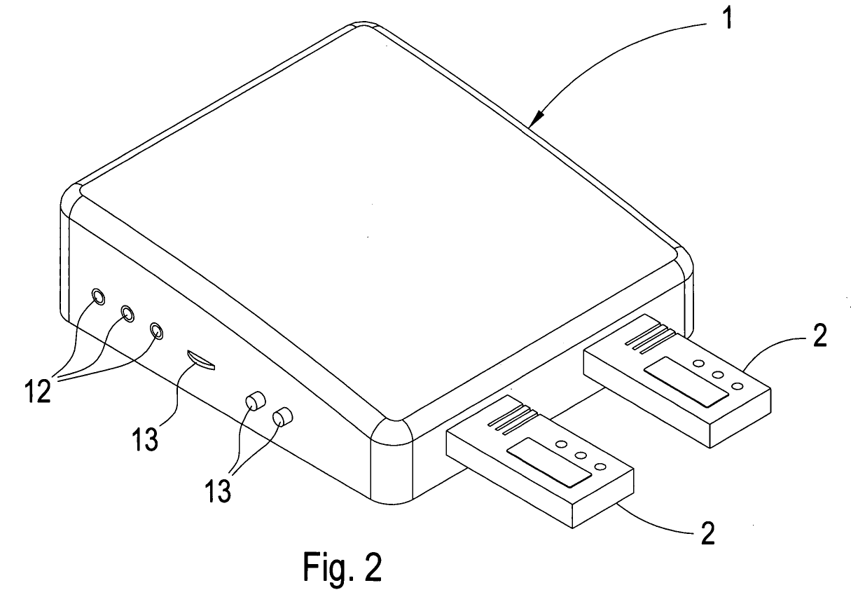

With reference to FIGS. 1 and 2, the schematic view and perspective view of the USB music player of the present invention are illustrated. The USB music player of the present invention has the following components.

Two USB connecting slots 11 serve for receiving two portable memories 2, such as thumb disk, or pen disk, each having a respective USB connector 21 so as to read music format stored in the two portable memories 2.

A plurality of insertion hole 12 and a plurality of buttons 13 are included. Then music signals are transferred to an external playing device (not shown) through the insertion holes 12. The playing of music is controlled by the control keys 13.

Other than playing music in the portable memories 2, the data can be transferred and recorded between the two portable memories 2 and the USB music player 1.

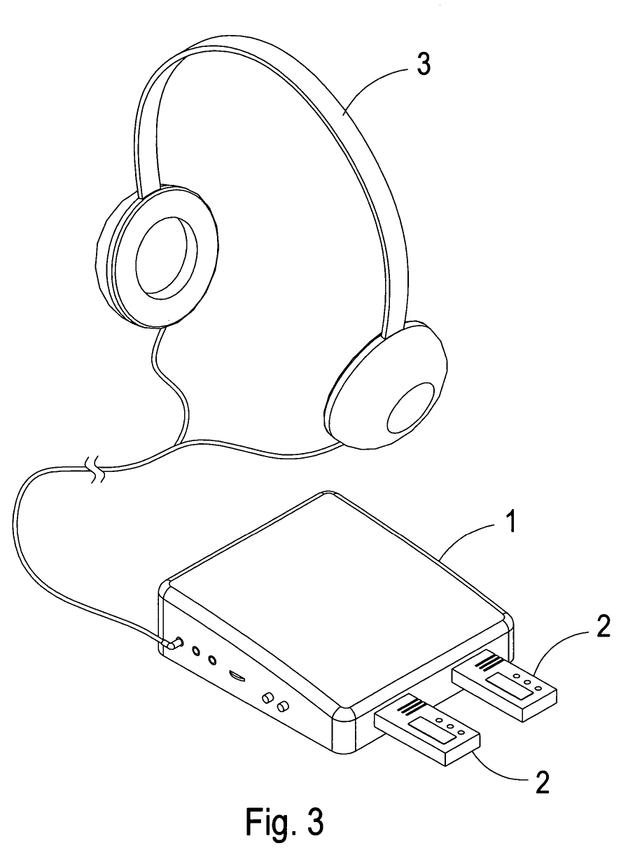

Referring to FIG. 3, another embodiment of the present invention is illustrated. It is illustrated that the USB music player of the present invention is connected to an earphone set 3 so that the user can hear music through the earphone set 3.

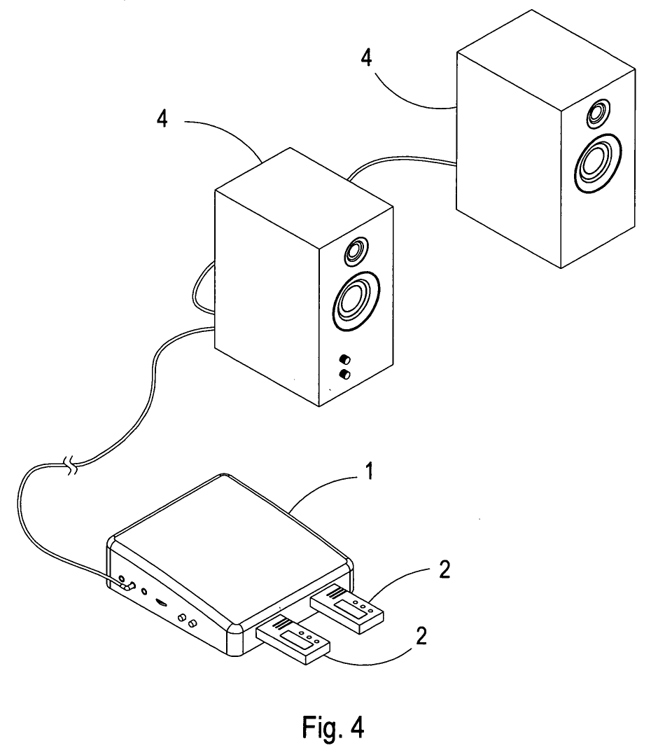

With reference to FIG. 4, it is illustrated that the present invention is connected to a trumpet 4. It is appreciated that the USB music player of the present invention can read the music format in any of the two portable memories 2. Furthermore, music signals can be outputted through an external trumpet 4 (or an amplifier).

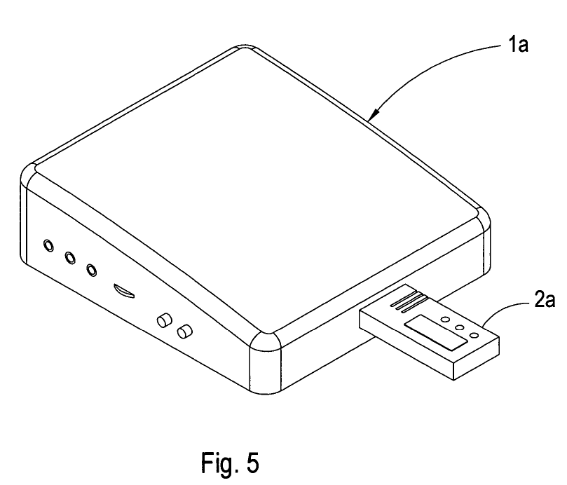

Referring to FIG. 5, another embodiment of the USB music player of the present invention is illustrated. The USB music player 1a can be used for only one portable memory 2a, that is, there is only one USB connecting slot 11. Similarly, music signals can be played through a trumpet or an earphone set.

Advantages of the present invention will be described here. The USB music player can be connected to a plurality of portable memories so that the user can select music in the portable memories. Thus more music can be stored and selected. The data in the USB music player and portable memories can be transferred and recorded to one another without using a computer. The USB music player of the present invention has a simple structure, can be operated easily and has longer lifetime.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A USB music player comprising:
two USB connecting slots for receiving two portable memories each having a respective USB connector so as to read music format stored in the two portable memories; wherein data is transferred and recorded between the two portable memories and the USB music player; and
a plurality of insertion hole and a plurality of buttons; wherein music signals are transferred to an external playing device through the insertion holes; and the playing of music is controlled by the control keys.

2. The USB music player as claimed in claim 1, wherein a wire earphone set is connected to one of the plurality of insertion holes.

3. The USB music player as claimed in claim 1, wherein a wireless earphone set is connected to one of the plurality of insertion holes.

4. The USB music player as claimed in claim 1, wherein a trumpet is connected to one of the plurality of insertion holes.

5. The USB music player as claimed in claim 1, wherein an amplifier is connected to one of the plurality of insertion holes.

6. The USB radio player as claimed in claim 1, wherein the portable memory is one of a pen disk and a thumb disk.

7. A USB music player comprising:
one USB connecting slot for receiving one portable memory each having a respective USB connector so as to read music format stored in the two portable memories; wherein data is transferred and recorded between the portable memory and the USB music player; and
a plurality of insertion hole and a plurality of buttons; wherein music signals are transferred to an external playing device through the insertion holes; the playing of music is controlled by the control keys.

8. The USB music player as claimed in claim 7 wherein a wire earphone set is connected to one of the plurality of insertion holes.

9. The USB music player as claimed in claim 7 wherein a wireless earphone set is connected to one of the plurality of insertion holes.

10. The USB music player as claimed in claim 7, wherein a trumpet is connected to one of the plurality of insertion holes.

11. The USB music player as claimed in claim 7, wherein an amplifier is connected to one of the plurality of insertion holes.

12. The USB radio player as claimed in claim 7, wherein the portable memory is one of a pen disk and a thumb disk.
